(19) United States
(12) Patent Application Publication
(10) Pub. No.: US 2024/0153118 A1
(43) Pub. Date: May 9, 2024

(54) METHOD AND DEVICE FOR ESTIMATING A DEPTH MAP ASSOCIATED WITH A DIGITAL HOLOGRAM REPRESENTING A SCENE AND COMPUTER PROGRAM ASSOCIATED

(71) Applicant: FONDATION B-COM, CESSON SEVIGNE (FR)

(72) Inventors: Nabil MADALI, RENNES (FR); Antonin GILLES, RENNES (FR); Patrick GIOIA, SERVON-SUR-VILAINE (FR); Luce MORIN, RENNES (FR)

(21) Appl. No.: 18/499,924

(22) Filed: Nov. 1, 2023

(30) Foreign Application Priority Data
Nov. 3, 2022 (FR) 2211433

(51) Int. Cl. G06T 7/55; G06T 17/00

(52) U.S. Cl. CPC G06T 7/55; G06T 17/00; G06T 2207/20081; G06T 2207/20084

(57) ABSTRACT

A method for estimating a depth map associated with a hologram representing a scene, the method includes steps of: reconstruction of images of the scene, each image being associated with a depth; decomposition of each image into a plurality of thumbnails adjacent to each other, each thumbnail being associated with the depth and including a plurality of pixels; determination, for each thumbnail, of a focus map by supplying, at the input of a network of neurons, values associated with the pixels of the thumbnail, to obtain, at the output of the network, the focus map including a focus level associated with the pixel concerned; and determination of a depth value, for each point of a depth map, as a function of the focus levels obtained. The invention also relates to an estimation device and an associated computer program.

### TECHNICAL FIELD OF THE INVENTION

The present invention relates to the technical field of digital holography.

It relates in particular to a method and a device for estimating a depth map associated with a digital hologram representing a scene. It also relates to an associated computer program.

### STATE OF THE ART

Digital holography is an immersive technology that records the characteristics of a wave diffracted by an object present in a three-dimensional scene so as to reproduce a three-dimensional image of that object. The digital hologram obtained then contains all the information allowing this three-dimensional scene to be described.

However, extracting this information from the digital hologram itself in order to reconstruct the three-dimensional scene is not simple because the plane of the digital hologram does not comprise the spatial location of objects in the three-dimensional scene.

It is particularly known to use depth determination methods (or “Depth from focus” according to the designation of Anglo-Saxon origin) in relation to the plane of the hologram in order to determine, from the hologram, information concerning the geometry of the scene. An example of such a method is for example described in the article “Depth from focus”, by Grossmann, Pavel, Pattern Recognit. Lett. 5, 63-69, 1987.

In such methods, a reconstruction volume is obtained from several holographic reconstruction planes calculated at different focus distances chosen within a predefined interval. From these reconstruction planes, the associated depth is estimated by applying, on each of these planes, focusing operators in order to select, for each pixel, the depth of the reconstruction plane for which the focus is optimal.

However, such methods take a long time to be implemented and are very expensive in terms of computational resources.

### Presentation of the Invention

In this context, the present invention proposes to improve the determination of depth values relative to the plane of a digital hologram associated with a three-dimensional scene.

More particularly, according to the invention, we propose a method for estimating a depth map associated with a digital hologram representing a scene, the method comprising steps of:
reconstruction of a plurality of images of the scene from the digital hologram, each reconstructed image being associated with a depth of the scene,
decomposition of each reconstructed image into a plurality of thumbnails, said thumbnails of said plurality being adjacent to each other, each thumbnail being associated with the depth of the scene corresponding to the reconstructed image concerned, each thumbnail comprising a plurality of pixels,
determination, for each thumbnail, of a focus map by supplying, at the input of an artificial neural network, the values associated with said pixels of the thumbnail concerned, so as to obtain, at the output of the artificial neural network, said focus map comprising a focus level associated with the pixel concerned, and
determination of a depth value, for each point of a depth map, as a function of the focus levels obtained respectively for the pixels associated with said point of the depth map in the focusing maps respectively determined for the thumbnails containing a pixel corresponding to said point of the depth map.

Thus, the different thumbnails processed are independent of each other because they are made up of sets of disjoint pixels. This independence then allows faster implementation of the method. In addition, the necessary computing resources are less expensive thanks to the limited number of areas (that means the different thumbnails) to analyze.

Furthermore, the use of the artificial neural network allows faster processing of all the thumbnails and a more precise determination of the focuslevels associated with the pixels of the thumbnails.

Other non-limiting and advantageous characteristics of the method according to the invention, taken individually or in all technically possible combinations, are as follows:
for each point of the depth map, the associated depth value is obtained by determining the depth corresponding to the highest focus level among all pixels associated with said point of the depth map in the thumbnails containing said pixels;
the artificial neural network is a convolutional neural network; and
the reconstruction step is implemented in such a way that the reconstructed images are respectively associated with depths uniformly distributed between a minimum depth and a maximum depth of the scene.

The present invention also relates to a device for estimating a depth map associated with a digital hologram representing a scene, the device comprising:
a module for reconstructing a plurality of images of the scene from the digital hologram, each reconstructed image being associated with a depth of the scene,
a module for decomposing each reconstructed image into a plurality of thumbnails, said thumbnails of said plurality being adjacent to each other, each thumbnail being associated with the depth of the scene corresponding to the reconstructed image concerned, each thumbnail comprising a plurality of pixels,
a module for determining, for each thumbnail, a focus map by supplying, at the input of an artificial neural network, the values associated with said pixels of the thumbnail concerned, so as to obtain, at the output of the artificial neural network, said focus map comprising a focus level associated with the pixel concerned, and
a module for determining a depth value, for each point of a depth map as a function of the focus levels obtained respectively for the pixels associated with said point of the depth map in the thumbnails containing said pixels.

The present invention finally relates to a computer program comprising instructions executable by a processor and designed to implement a method as introduced previously when these instructions are executed by the processor.

Of course, the different characteristics, variants and embodiments of the invention can be associated with each other in various combinations as long as they are not incompatible or exclusive of each other.

### DETAILED DESCRIPTION OF THE INVENTION

In addition, various other characteristics of the invention emerge from the appended description made with reference to the drawings which illustrate non-limiting forms of embodiment of the invention and where:

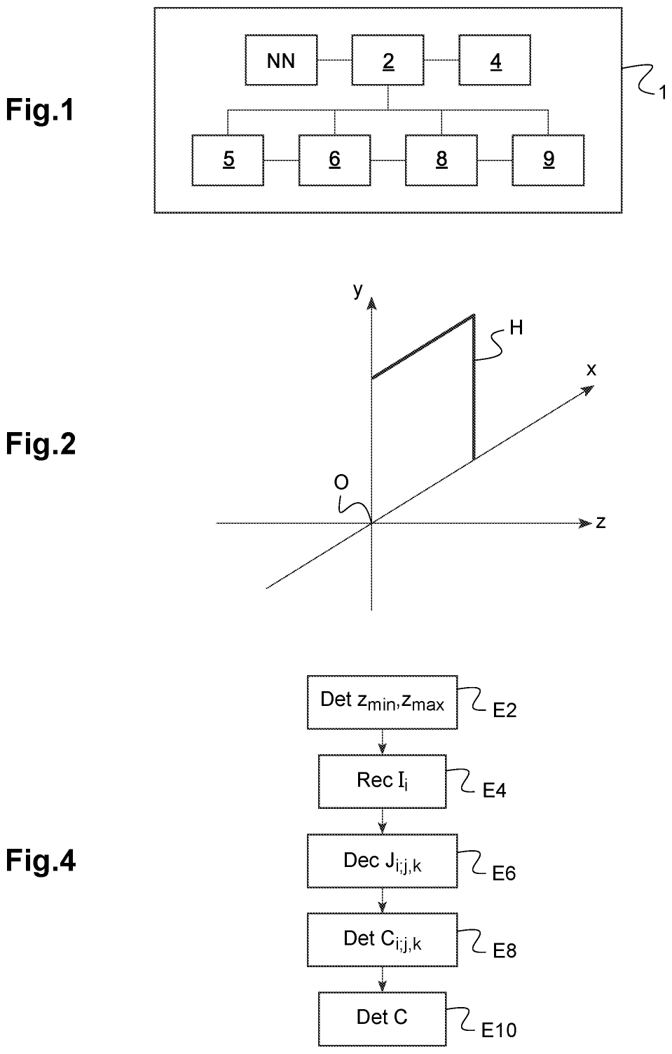

FIG. 1 represents, in a functional form, a device for estimating a depth map designed to implement a method for estimating a depth map in accordance with the invention,

FIG. 2 represents an example of a digital hologram associated with the depth map estimated according to the invention,

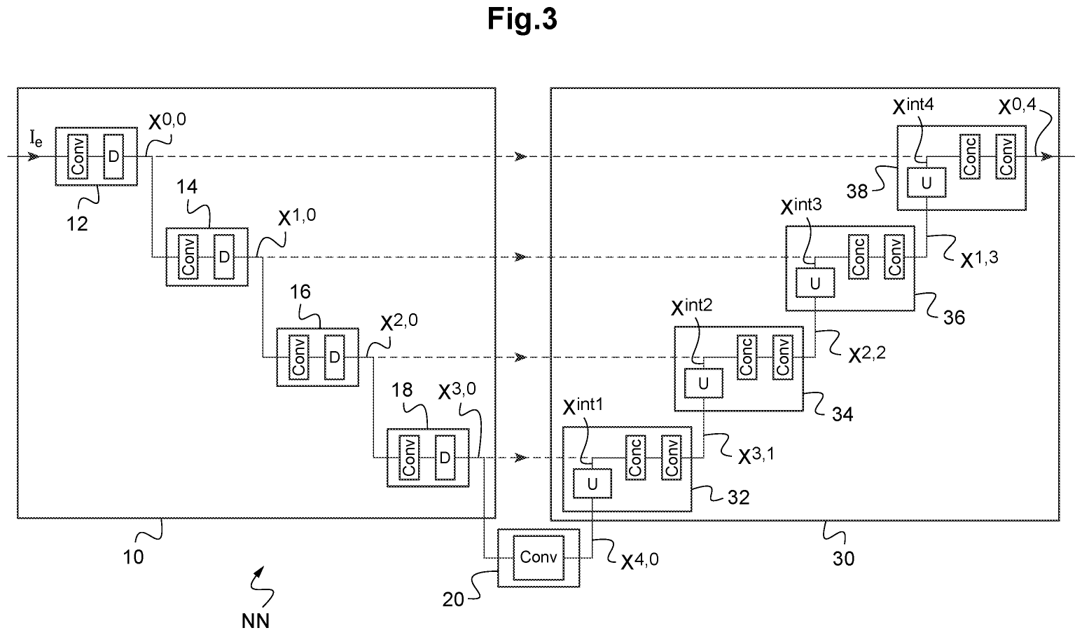

FIG. 3 is a schematic representation of an example of architecture of an artificial neural network (or a network of artificial neurons) implemented during the method of estimating a depth map according to the invention, and

FIG. 4 represents, in a flowchart form, an example of a method for estimating a depth map according to the invention.

It should be noted that, in these figures, the structural and/or functional elements common to the different variants may have the same references.

FIG. 1 represents, in a functional form, a device 1 for estimating (also denoted device 1 in the following) a depth map C from a digital hologram H.

The digital hologram H represents a given three-dimensional scene. This three-dimensional scene comprises, for example, one or more objects. The three-dimensional scene is defined in a marker (O, x, y, z).

As shown in FIG. 2, the digital hologram H is defined by a matrix of pixels in the (x, y) plane. The z axis, called the z depth axis, is orthogonal to the (x, y) plane of the digital hologram H. As can be seen in FIG. 2, the digital hologram H is here defined in the equation plane z=0.

The digital hologram H, for example, has a size of 1024×1024 pixels here.

The device 1 for estimating a depth map C is designed to estimate the depth map C associated with the digital hologram H. For this, the device 1 comprises a processor 2 and a storage device 4. The storage device 4 is for example a hard disk or a memory.

The device 1 also comprises a set of functional modules. It comprises for example a reconstruction module 5, a decomposition module 6, a module 8 for determining a focus map C_{i;j,k} (or focusing map) and a module 9 for determining a depth value d_{js+q,ks+r}.

Each one of the different modules described is for example implemented by means of computer program instructions designed to implement the module concerned when these instructions are executed by the processor 2 of the device 1 for estimating the depth map C.

However, as a variant, at least one of the aforementioned modules can be implemented by means of a dedicated electronic circuit, for example an integrated circuit with a specific application.

The processor 2 is also designed to implement an artificial neural network NN, involved in the process of estimating the depth map C associated with the digital hologram H.

An example of architecture of this artificial neural network NN is shown in FIG. 3. In this example, the artificial neural network NN is a convolutional neural network, for example of the U-Net type.

Generally speaking, such an artificial neural network NN comprises a plurality of convolution layers distributed according to different levels, as explained below and represented in FIG. 3. More details on an artificial neural network of the U-Net type can also be found in the article “U-Net: Convolutional Networks for Biomedical Image Segmentation” by Ronneberger, O., Fischer, P. & Brox, T., CoRR, abs/1505.04597, 2015.

In order to describe the architecture of the artificial neural network NN, we consider here that an image Iₑ is provided at an input of this network of artificial neurons NN. In practice, this image Iₑ is an image derived from the digital hologram H, as will be explained subsequently.

As shown in FIG. 3, the artificial neural network NN here comprises a first part 10, a connecting bridge 20 and a second part 30.

The first part 10 is a so-called contraction part. Generally speaking, this first part 10 has the encoder function and makes it possible to reduce the size of the image provided at an input while retaining (saving) its characteristics. For this, it comprises four levels here 12, 14, 16, 18. Each level 12, 14, 16, 18 comprises a convolution block Cony and a subsampling block D.

The convolution block Cony comprises at least one convolution layer whose kernel is a matrix of size n×n. Preferably here, each convolution block has two successive convolution layers. Here, each convolution layer has a kernel with a matrix of size 3×3.

Then, the convolution layer (or convolution layers if there are several) is followed by an activation function of rectified linear unit type (or ReLu for “Rectified Linear Unit” according to the commonly used designation of Anglo-Saxon origin). Finally, the convolution block Cony comprises, for the result obtained after application of the activation function, a so-called batch normalization. Here, this batch is composed by (or constituted by) the number of images provided as an input to the artificial neural network NN. During the learning step of the artificial neural network as described below, the batch size is greater than or equal to 1 (that means. at least two images are provided at the input to allow training the network of artificial so neurons). In the case of the depth map estimation method as described subsequently, the batch size is, for example here, given by the number of reconstructed images Iᵢ (see below).

As shown in FIG. 3, at the output of the convolution block Cony, each level 12, 14, 16, 18 comprises the subsampling block D. This subsampling block D makes it possible to reduce the dimensions of the result obtained at the output of the convolution block Cony. This involves, for example, a reduction by 2 of these dimensions, for example by selecting the maximum pixel value among the four pixels of a pixel window of size 2×2 (we then speak of “max pooling 2×2” according to the commonly used Anglo-Saxon expression).

Thus, taking the example shown in FIG. 3, the input image Iₑ is provided at an input to the first level 12 of the first part 10. The convolution block Cony and the subsampling block D of this first level 12 then make it possible to obtain, at the output, a first data X^{0, 0}. Here, this first data X^{0, 0} has for example dimensions reduced by half compared to the input image Iₑ.

Then, this first data X^{0, 0} is provided as an input to the second level 14 of the first part 10 so as to obtain, at the output thereof, a second data X^{1, 0}. Here, this second data X^{1, 0} has for example dimensions reduced by half compared to the first data X^{0, 0}.

The second data data X^{1, 0} is provided as an input to the third level 16 of the first part 10 so as to obtain, at the output thereof, a third data X^{2, 0}. Here, this third data X^{2, 0} has for example dimensions reduced by half compared to the second data X^{1, 0}.

Then, this third data X^{2, 0} is provided as an input to the fourth level 18 of the first part 10 so as to obtain, at the output, a fourth data X^{3, 0}. Here, this fourth data X^{3, 0} has for example dimensions reduced by half compared to the third data X^{2, 0}.

Thus, the processing operations of the input image Iₑ by the first part 10 of the artificial neural network NN can be expressed in the following form:

X^{i,j}=D(Conv(X^{i-1,j}))
with j=0 and i between 1 and 4, the operator Cony corresponding to the processing implemented by the convolution block Cony and the operator D being associated with the subsampling block D.

As can be seen in FIG. 3, the artificial neural network NN comprises, at the output of the first part 10, the connection bridge 20. This connection bridge 20 makes it possible to make the link between the first part 10 and the second part 30 of the artificial neural network NN. It comprises a convolution block Cony as described previously. Here, it thus receives as an input the fourth data X^{3, 0} and provides, as an output, a fifth data X^{4, 0}.

The second part 30 of the artificial neural network NN is called expansion. Generally speaking, this second part 30 has the decoder function and makes it possible to form an image having the size of the image provided at the input and which only contains the characteristics essential to the processing.

For this, the second part 30 here comprises four levels 32, 34, 36, 38. By analogy with the first part 10, we define the first level 38 of the second part 30 as that positioned at the same level as the first level 12 of the first part 10. The second level 36 of the second part 30 is positioned at the same level as the second level 14 of the first part 10 of the artificial neural network NN. The third level 34 of the second part is positioned at the same level as the third level 16 of the first part 10 of the artificial neural network NN. Finally, the fourth level 32 of the second part 30 is positioned at the same level as the fourth level 18 of the first part 10 of the artificial neural network NN. This definition is used to match the levels of the artificial neural network processing data of the same dimensions.

Each level 32, 34, 36, 38 comprises an oversampling block U, a concatenation block Conc and a convolution block Cony (such as that introduced previously in the first part).

Each oversampling block U aims at increasing the dimensions of the data received at an input. This is an “upscaling” operation according to the commonly used Anglo-Saxon expression. For example here, the dimensions are multiplied by 2.

Following the oversampling block U, each level 32, 34, 36, 38 comprises the concatenation block Conc. The latter aims at concatenating the data obtained at the output of the oversampling block U of the level concerned with the data of the same size obtained at the output of one of the levels 12, 14, 16, 18 of the first part 10 of the artificial neural network NN. The involvement of data from the first part of the artificial neural network NN in the concatenation operation is shown in broken lines in FIG. 3.

This concatenation block then allows the transmission of information of the extracted high frequencies obtained in the first part 10 of the artificial neural network NN also in the second part 30. Without this concatenation block Conc, this information could be lost following the multiple operations of undersampling and oversampling present in the artificial neural network NN.

Then, at the output of the concatenation block Conc, each level 32, 34, 36, 38 of the second part 30 comprises a convolution block Cony such as that described previously in the first part 10 of the artificial neural network NN. Here, each convolution block Cony notably comprises at least one convolution layer followed by a rectified linear unit type activation function and a batch normalization operation.

Based on the example shown in FIG. 3, the fifth data X^{4, 0} is provided at the input of the fourth level 32 of the second part 30. The oversampling bloc U then makes it possible to obtain at the output a first intermediate data X^{int1}, which has the same dimensions as the fourth data X^{3, 0} obtained at the output of the fourth level 18 of the first part 10. This first intermediate data X^{int1} and the fourth data X^{3, 0} then are concatenated by the concatenation block Conc. The result obtained at the output of the concatenation block Conc is then provided as an input to the convolution block Cony so as to obtain, at the output, a sixth data item X^{3, 1}.

That sixth data item X^{3, 1} then is provided at an input of the third level 34 of the second part 30 and, especially, at an input of the oversampling bloc U. At the output of that oversampling bloc U, a second intermediate data X^{int2}, which has the same dimensions as the third data X^{2, 0}, is obtained. The second intermediate data X^{int2} and the third data X^{2, 0} are concatenated by the concatenation block Conc. The result obtained at the output of the concatenation block Conc is provided at the input of the convolution block Conv so as to obtain, at the output, a seventh data item X^{2, 2}.

Then, as shown in FIG. 3, the seventh data X^{2, 2} is provided at an input of the second level 36 of the second part 30 (and therefore at an input of the oversampling block U of this second level 36). A third intermediate data X^{int3} is obtained at the output of this oversampling block U. This third intermediate data X^{int3} has the same dimensions as the second data X^{1, 0}. The third intermediate data X^{int3} and the second data X^{1, 0} are then concatenated by the concatenation block Conc. The result obtained at the output of the concatenation block Conc is provided at an input of the convolution block Conv so as to obtain, at the output, an eighth data item X^{1, 3}.

Then, this eighth data X^{1, 3} is provided at an input of the first level 38 of the second part 30. The oversampling block U then makes it possible to obtain a fourth data X^{int4}. The latter has the same dimensions as the first data X^{0, 0}. The fourth intermediate data X^{int4} and the first data X^{0, 0} are then concatenated by the concatenation block Conc. The result obtained at the output of the concatenation block Conc is provided at an input of the convolution block Conv so as to obtain, at the output, a final data X^{0.4}. This final data X^{0.4} has the same dimensions and the same resolution as the input image Iₑ. In practice, here, this final data X^{0, 4} is for example associated with a focus map (also denoted focusing map) as described below.

Thus, the processing operations of the fifth data item X^{4, 0} by the second part 30 of the artificial neural network NN can be expressed in the following form:

X_{i,j}=Conv(Conc[X^{i,0};U(X^{i+1,j-1})])
with j≥1 and i between 0 and 3, the operator Conv corresponding to the processing implemented by the convolution block Conv, the operator Conc corresponding to the processing implemented by the concatenation block Conc and the operator U being associated with the oversampling block U.

FIG. 4 is a flowchart representing an example of a method (or a process) for estimating the depth map C associated with the digital hologram H, implemented in the context described above. This method is for example implemented by the processor 2. Generally, this process is implemented by computer.

As shown in FIG. 4, the method begins at step E2 during which the processor 2 determines a minimum depth zₘᵢₙ and a maximum depth zₘₐₓ of the z coordinate in the three-dimensional scene of the digital hologram H. These minimum and maximum depths are for example previously recorded in the storage device 4.

The method then continues with a step E4 of reconstructing a plurality of two-dimensional images of the three-dimensional scene represented by the digital hologram H.

For this, the reconstruction module 5 is configured to reconstruct n images Iᵢ of the scene by means of the digital hologram H, with i being an integer ranging from 1 to n.

Each reconstructed image Iᵢ is defined in a reconstruction plane which is perpendicular to the depth axis of the digital hologram H. In other words, each reconstruction plane is perpendicular to the depth axis z. Each reconstruction plane is associated with a depth value, making it possible to associate a depth zᵢ with each reconstructed image Iᵢ, the index i referring to the index of the reconstructed image Iᵢ. Each depth value defines a distance between the plane of the digital hologram and the reconstruction plane concerned.

Preferably here, the reconstruction step E4 is implemented in such a way that the depths zᵢ associated with the reconstructed images Iᵢ are uniformly distributed between the minimum depth zₘᵢₙ and the maximum depth zₘₐₓ. In other words, the reconstructed images Iᵢ are uniformly distributed along the depth axis, between the minimum depth zₘᵢₙ and the maximum depth zₘₐₓ. Thus, the first reconstructed image I₁ is spaced from the plane of the digital hologram H by the minimum depth zₘᵢₙ while the last reconstructed image Iₙ is spaced from the plane of the digital hologram H by the maximum depth zₘₐₓ.

The reconstruction planes associated with the reconstructed images Iᵢ are for example spaced two by two by a distance zₑ. The distance zₑ between each reconstruction plane is for example of the order of 50 micrometers (μm).

Preferably, the n images obtained in reconstruction step E4 are calculated using a propagation of the angular spectrum defined by the following formula:

$${I}_{i} ( x , y ) = {F}^{- 1} \{ F ( H ) {e}^{j 2 π {z}_{i} \sqrt{{λ}^{- 2} - {f}_{χ}^{2} - {f}_{y}^{2}}} \} ( x , y )$$

with F and F⁻¹ corresponding to direct and inverse Fourier transforms, respectively, and fₓ and f_{y} being the frequency coordinates of the digital hologram H in the Fourier domain in a first spatial direction x and in a second spatial direction y of the digital hologram, λ being the acquisition wavelength of the digital hologram H, i being the index of the reconstructed image I with i ranging from 1 to n and z_{i being} the depth given in the reconstruction plane of the image Iᵢ.

Each reconstructed image Iᵢ is defined by a plurality of pixels. Preferably, the reconstructed images are formed of as many pixels as the digital hologram H. Thus, the reconstructed images Iᵢ and the digital hologram H are of the same size. For example, in the case of a digital hologram H of size 1024×1024, each reconstructed image Iᵢ also has a size of 1024×1024.

As shown in FIG. 4, the method continues in step E6. During this step, the decomposition module 6 is configured to decompose each reconstructed image Iᵢ obtained in step E4 into a plurality of thumbnails J_{i; j,k}. In other words, during this decomposition step E6, each reconstructed image Iᵢ is divided into a plurality of thumbnails J_{i;j,k}. In other words still, each thumbnail J_{i;j,k} corresponds to a sub-part of the reconstructed image I concerned.

Each thumbnail J_{i;j,k} is defined by the following formula:

J_{i;j,k}={|Iᵢ|(j·s:(j+1)·s,k·s:(k+1)·s)}

with

$$j = 1 … ⌊ \frac{{s}_{W}}{s} ⌋ and k = 1 … ⌊ \frac{{s}_{H}}{s} ⌋ ,$$

with s_{W} and s_{H} being the dimensions (respectively height and width) of the reconstructed image Iᵢ, s being the size of the thumbnail J_{i;j,k}, |x₁| being the notation corresponding to the module of the data x₁ and └x₂┘, the notation corresponding to the lower integer part of the number x₂. The notation y₁:y₂ means that, for the variable concerned, the thumbnail J_{i; j,k} is defined between pixel y₁ and pixel y₂. In other words, here, the previous formula defines the thumbnail J_{i; j,k}, according to dimension x, between pixels js and (j+1)s of the reconstructed image Iᵢ and, according to dimension y, between pixels ks and (k+1)s of the reconstructed image Iᵢ.

Each thumbnail J_{i; j,k} comprises a plurality of pixels. This plurality of pixels corresponds to a part of the pixels of the associated reconstructed image Iᵢ.

Here, the thumbnails J_{i; j,k} are adjacent to each other. In practice, each thumbnail J_{i;j,k} is formed from a set of contiguous pixels of the reconstructed image Iᵢ. Here, the sets of pixels of the reconstructed image Iᵢ (respectively forming each one of the thumbnails J_{i;j,k}) are disjoint. In other words, this means that the thumbnails J_{i; j,k} associated with a reconstructed image Iᵢ do not overlap with each other. Each thumbnail J_{i; j,k} therefore comprises pixels which do not belong to the other thumbnails associated with the same reconstructed image Iᵢ. In other words, the thumbnails J_{i; j,k} associated with a reconstructed image Iᵢ are independent of each other.

This property of independence between the thumbnails is particularly advantageous for the method according to the invention because it allows faster implementation. In addition, the necessary computing resources are less expensive thanks to the limited number of areas to analyze (namely the different thumbnails).

Since each thumbnail J_{i; j,k} is derived from a reconstructed image Iᵢ associated with a depth zᵢ, each thumbnail J_{i;j,k} is also associated with this same depth zᵢ (of the three-dimensional scene).

In the case where the digital hologram H has a size of 1024×1024, each thumbnail J_{i;j,k} can for example have a size of 32×32.

In the case where the digital hologram H has a size of I_{H}×I_{W}, each thumbnail J_{i; j,k} has a size of (32×s_{H})×(32×s_{W}) with s_{H}=I_{H}/1024 and s_{W}=I_{W}/1024.

This definition of the size of the thumbnails makes it possible to ensure a size of these thumbnails adapted to the size of the digital hologram H so as to improve the speed of implementation of the method for estimating the depth map associated with the digital hologram H.

As shown in FIG. 4, the method then continues in step E8. During this step, the processor 2 determines, for each thumbnail J_{i; j,k}, a focus map C_{i; j,k} (or focusing map). This focus map C_{i; j,k} includes a plurality of elements (each identified by the indices js+q, ks+r). Each element of the focusing map C_{i;j,k} is associated with a pixel of the thumbnail J_{i; j,k} concerned.

Here, each element of the focus map C_{i; j,k} corresponds to a focus level (corresponding to a focus level associated with the pixel concerned in the thumbnail J_{i; j,k}). In other words, the focusing map C_{i; j,k} associates with each pixel of the thumbnail J_{i;j,k} concerned a level of focus.

In practice, this step E8 is implemented via the artificial neural network NN., At an input, the latter receives each one of the thumbnails J_{i; j,k} and provides at the output the focus levels (also denoted focusing levels) associated with each one of the pixels in the thumbnail J_{i; j,k} concerned.

More particularly, the artificial neural network NN receives, at the input, each one of the pixels of the thumbnail J_{i; j,k} and provides, at the output, the associated focus level (or focusing level). This focusing level is for example comprised between 0 and 1 and is equivalent to a level of sharpness associated with the pixel concerned. For example, in the case of a blurry pixel, the focus level is close to 0 while in the case of a noticeably sharp pixel, the focus level is close to 1.

Advantageously, the use of the artificial neural network allows faster processing of all the thumbnails and a more precise determination of the focusing levels associated with the pixels of the thumbnails.

Prior to implementing the estimation method, a learning step (not shown in the figures) allows the training of the artificial neural network NN. For this, computer-calculated holograms are used, for example. For these computed holograms, the exact geometry of the scene (and therefore the associated depth map) is known. A set of basic images comes from these calculated holograms.

For each base image in this set, each pixel is associated with a focus level. Indeed, for each pixel of each base image, the focus level is equal to 1 if the corresponding pixel, in the depth map, is equal to the associated depth. Otherwise, the focus level is 0.

The training step then consists of adjusting the weights of the nodes of the different convolution layers comprised in the different convolution blocks described previously so as to minimize the error between the focusing levels obtained at the output of the artificial neural network NN (when the basic images are provided at an input of this network) and those determined from the known depth map. For example, a crossed-entropy loss method can be used here in order to minimize the distance between the focus levels obtained at the output of the artificial neural network NN (when the base images are provided at an input of this network) and those determined from the known depth map.

In other words, the weights of the nodes of the different convolution layers are adjusted so as to converge the focus levels obtained at the output of the artificial neural network NN towards the focus levels determined from the known depth map.

In practice, the artificial neural network NN receives at the input all the thumbnails J_{i;j,k} associated with each reconstructed image Iᵢ and proceeds to parallel processing of each of the thumbnails J_{i;j,k}.

Alternatively, the thumbnails J_{i; j,k} could be processed successively, one after the other.

At the end of step E8, the processor 2 therefore knows, for each thumbnail J_{i;j,k}, the associated focusing map C_{i; j,k} which lists the focusing levels obtained at the output of the artificial neural network NN associated with each pixel of the thumbnail J_{i; j,k} concerned. Each focusing map C_{i; j,k} is associated with the corresponding thumbnail J_{i;j,k}, and thus with the depth zᵢ (of the three-dimensional scene).

As shown in FIG. 4, the method then comprises a step E10 of estimating the depth map C associated with the digital hologram H. This depth map C comprises a plurality of depth values d_{js+q, ks+r}. Each depth value d_{js+q, ks+r} is associated with a pixel among the different pixels of the thumbnails J_{i; j,k}. The depth value d_{js+q, ks+r} is determined based on the focus levels determined in step E8.

Indeed, during step E8, as each reconstructed images of the plurality of reconstructed images Iᵢ corresponds to a different depth zᵢ, a pixel of a thumbnail is associated with different focusing levels (depending on the depth of the reconstructed image I from which the thumbnail concerned is derived). In other words, for each pixel (associated with a depth value d_{js+q, ks+r} of the depth map C), several focusing levels are known.

Thus, here, processor 2 determines, for each pixel associated with the depth value d_{js+q, ks+r} concerned, the depth for which the focusing level is the highest:

d_{js+q,ks+r}=argmax_{i=1 . . . N}(C_{i;j,k}(q,r))
with (js+q, ks+r) being the pixel to which the determined depth value is assigned, NN being the operator corresponding to the implementation of the artificial neural network NN and argmax, the operator translating the determination of the maximum value of the focus level (obtained at the output of the artificial neural network).

In other words, for each index pixel (js+q, ks+r), processor 2 determines the depth at which the focus level is highest. This depth then corresponds to the depth value d_{js+q, ks+r} (element of depth map C).

Alternatively, the depth value could be determined using another method than determining the maximum value of the focus level. For example, an area formed by a plurality of adjacent pixels may be defined and the depth value may be determined by considering the depth for which a maximum deviation is observed from the average of the focus levels over the defined pixel area.

At the end of step E10, therefore, the depth map C is for example estimated here from these determined depth values. Thus, each element of the depth map C comprises a depth value d_{js+q, ks+r} associated with each pixel having the index (js+q, ks+r).

This estimated depth map C ultimately makes it possible to have spatial information in the form of a matrix of depth values representing the three-dimensional scene associated with the digital hologram H.

Of course, the method described above for a digital hologram applies in the same way to a plurality of holograms. For a plurality of digital holograms, the implementation of the method can be successive for each hologram or in parallel for the plurality of digital holograms.

1. Method for estimating a depth map associated with a digital hologram representing a scene, the method comprising:
reconstructing a plurality of images of the scene from the digital hologram, each of the reconstructed images being associated with a depth of the scene,
decomposing each reconstructed image into a plurality of thumbnails, said thumbnails of said plurality of thumbnails being adjacent to each other, each said thumbnail being associated with the depth of the scene corresponding to the reconstructed image concerned, each said thumbnail comprising a plurality of pixels,
determining, for each said thumbnail, a focus map by supplying, at an input of an artificial neural network, values associated with said pixels of the thumbnail concerned, so as to obtain, at an output of the artificial neural network, said focus map comprising a focus level associated with the pixel concerned, and
determining a depth value, for each point of the depth map, as a function of the focus levels obtained respectively for the pixels associated with said point of the depth map in the focus maps respectively determined for the thumbnails containing a given said pixel corresponding to said point of the depth map.

2. The method according to claim 1, wherein, for each said point of the depth map, the associated depth value is obtained by determining the depth corresponding to a highest said focus level among all the pixels associated with said point of the depth map in the thumbnails containing said pixels.

3. The method according to claim 1, wherein the artificial neural network is a convolutional neural network.

4. The method according to claim 1, wherein the reconstructing is implemented in such a way that the reconstructed images are respectively associated with said depths uniformly distributed between a minimum depth and maximum depth of the scene.

5. Device for estimating a depth map associated with a digital hologram representing a scene, the device comprising:
a reconstruction module of a plurality of images of the scene from the digital hologram, each of the reconstructed images being associated with a depth of the scene,
a decomposition module of each reconstructed image into a plurality of thumbnails, said thumbnails of said plurality of thumbnails being adjacent to each other, each said thumbnail being associated with the depth of the scene corresponding to the reconstructed image concerned, each said thumbnail comprising a plurality of pixels,
a determination module, for each said thumbnail, a focus map by supplying, at an input of an artificial neural network, values associated with said pixels of the thumbnail concerned, so as to obtain, at an output of the artificial neural network, said focus map comprising a focus level associated with the pixel concerned, and
a module for determining a depth value for each point of the depth map according to the focus levels obtained respectively for the pixels associated with said point of the depth map in the thumbnails containing said pixels.

6. A non-transitory computer-readable medium on which is stored a computer program comprising instructions executable by a processor and designed to implement the method according to claim 1 when the instructions are executed by the processor.

7. The method according to claim 2, wherein the artificial neural network is a convolutional neural network.

8. The method according to claim 2, wherein the reconstructing is implemented in such a way that the reconstructed images are respectively associated with said depths uniformly distributed between a minimum depth and maximum depth of the scene.

9. The method according to claim 3, wherein the reconstructing is implemented in such a way that the reconstructed images are respectively associated with said depths uniformly distributed between a minimum depth and maximum depth of the scene.

10. The method according to claim 7, wherein the reconstructing is implemented in such a way that the reconstructed images are respectively associated with said depths uniformly distributed between a minimum depth and maximum depth of the scene.

11. A non-transitory computer-readable medium on which is stored a computer program comprising instructions executable by a processor and designed to implement the method according to claim 2 when the instructions are executed by the processor.

12. A non-transitory computer-readable medium on which is stored a computer program comprising instructions executable by a processor and designed to implement the method according to claim 3 when the instructions are executed by the processor.

13. A non-transitory computer-readable medium on which is stored a computer program comprising instructions executable by a processor and designed to implement the method according to claim 4 when the instructions are executed by the processor.

14. A non-transitory computer-readable medium on which is stored a computer program comprising instructions executable by a processor and designed to implement the method according to claim 7 when the instructions are executed by the processor.

15. A non-transitory computer-readable medium on which is stored a computer program comprising instructions executable by a processor and designed to implement the method according to claim 8 when the instructions are executed by the processor.

16. A non-transitory computer-readable medium on which is stored a computer program comprising instructions executable by a processor and designed to implement the method according to claim 9 when the instructions are executed by the processor.

17. A non-transitory computer-readable medium on which is stored a computer program comprising instructions executable by a processor and designed to implement the method according to claim 10 when the instructions are executed by the processor.
